(19) United States
(12) Patent Application Publication
(10) Pub. No.: US 2026/0278091 A1
(43) Pub. Date: Sep. 17, 2026

(54) METHODS AND SYSTEMS FOR GENERATING TRAINING DATA FOR USE IN MALWARE DETECTION

(71) Applicant: Versa Networks, Inc., Santa Clara, CA (US)

(72) Inventors: Jayakrishnan Iyer, Morgan Hill, CA (US); Akshay Agarwal, Bangalore (IN); Ayush Sahu, Bangalore (IN)

(21) Appl. No.: 19/193,421

(22) Filed: Apr. 29, 2025

Related U.S. Application Data
(60) Provisional application No. 63/770,696, filed on Mar. 12, 2025.

(51) Int. Cl. G06F 21/56

(52) U.S. Cl. CPC G06F 21/56

(57) ABSTRACT

In an embodiment, a method for automated generation of training data in a malware detection system includes acquiring metadata from one or more data sources for a plurality of malware samples, applying a coarse filtering function to the metadata to produce a first subset of malware samples, and performing a granular selection for the first subset by extracting features from the plurality of malware samples and grouping the malware samples based on feature similarities to form at least one cluster. A second subset of malware samples representing diverse malware families and threat categories is generated from the at least one cluster and is compared to a predefined threshold indicating at least one of a minimum number of new malware samples or a target threat distribution. Upon determining that the second subset satisfies the predefined threshold, a machine learning model is trained using the second subset for malware detection.

### BACKGROUND

Modern organizations with distributed endpoints, such as corporate offices or remote employees, rely on advanced cybersecurity solutions to safeguard critical data and operations. The cybersecurity solutions, such as malware detections systems, are typically trained on the known threat data. Because the threat data is aggregated and processed from disparate sources, shortcomings in coverage or freshness of the threat data may create gaps that reduce the overall effectiveness of the malware detection systems.

For effective malware detection, various techniques have been implemented, such as signature-based techniques, static file analysis, dynamic analysis, and the use of honeypots and blacklists/whitelists. Each of these known methods, however, presents significant limitations when facing modern cybersecurity challenges. Signature-based detection often fails to identify new or evolving threats that do not match existing signatures. Static analysis may not detect sophisticated malware designed to evade detection, and dynamic analysis, while more effective at detecting behavior-based threats, can be highly resource-intensive and less effective against advanced persistent threats that exhibit evasive maneuvers.

Machine Learning (ML) and Artificial Intelligence (AI) approaches have been introduced to address such evolving threats by continuously updating detection models. However, these ML and AI techniques typically require large volumes of high-quality and diverse training data. Because this training data must be acquired, filtered, and organized from multiple repositories, inefficiencies in data handling or bias in data selection may lead to degraded model performance and an increased rate of false positives.

### SUMMARY

In accordance with an embodiment of the invention, a method for automated selection of training data in a malware detection system is disclosed. The method includes acquiring metadata from one or more data sources for a plurality of malware samples, applying a coarse filtering function to the metadata for generating a first subset of malware samples, and performing a granular selection for the first subset. The granular selection is performed by extracting one or more features from each of the plurality of malware samples in the first subset and grouping malware samples based on similarities among the extracted features to form at least one cluster. The method further includes generating a second subset of malware samples from the at least one cluster representing diversity across a plurality of malware families and threat categories, and comparing the second subset with a predefined threshold, indicating at least one of a minimum number of new malware samples or a target distribution of threat categories, for determining if the second subset satisfies the predefined threshold. A machine learning model is trained for malware detection using the second subset upon determining that the second subset satisfies the predefined threshold.

In an embodiment, the acquired metadata is stored in a data repository configured to facilitate querying based on metadata attributes. The metadata includes at least a file identifier and at least one behavioural or static file attribute.

In an embodiment, the coarse filtering function applies one or more broad criteria including at least a threat severity level or submission date.

In an embodiment, the predefined threshold is modified based on historical model performance metrics that include at least one of accuracy, precision, recall, or false-positive rate.

In an embodiment, the data repository is partitioned according to submission dates, threat categories, or file attributes to enable faster retrieval of metadata.

In an embodiment, the step of granular selection further comprises applying a dimensionality reduction process prior to grouping the malware samples into clusters.

In an embodiment, the second subset is monitored for redundancy by comparing newly selected malware samples to previously used training data and excluding duplicates before initiating a training process.

In an embodiment, the coarse filtering function excludes malware samples below a specified threat severity level to reduce the data volume processed in the granular selection operation.

In an embodiment, the second subset is updated to increase diversity if the number of samples associated with an underrepresented malware family is below a defined threshold.

In an embodiment, at least one performance metric is logged from the initiated training process, and one or more filtering parameters of the coarse filtering process are adjusted in response to suboptimal performance.

In an embodiment, a scheduling mechanism is applied to automatically repeat the steps of acquiring metadata, applying the coarse filtering function, performing the granular selection, generating a second subset, and comparing at predetermined intervals or upon detecting at least one trigger event that indicates a change in threat landscape or model performance.

In accordance with another embodiment of the invention, a non-transitory computer-readable medium storing instructions that, when executed by one or more processors, cause a computing system to perform operations for automated generation of training data in a malware detection system. The operations include acquiring metadata from one or more data sources for a plurality of malware samples, applying a coarse filtering function to the metadata for generating a first subset of malware samples, and performing a granular selection for the first subset. The granular selection is performed by extracting one or more features from each of the plurality of malware samples in the first subset and grouping malware samples based on similarities among the extracted features to form at least one cluster. The operations further include generating a second subset of malware samples from the at least one cluster representing diversity across a plurality of malware families and threat categories, and comparing the second subset with a predefined threshold, indicating at least one of a minimum number of new malware samples or a target distribution of threat categories, for determining if the second subset satisfies the predefined threshold. A machine learning model is trained for malware detection using the second subset upon determining that the second subset satisfies the predefined threshold.

In accordance with another embodiment of the invention, a malware detection system for automated generation of training data in a malware detection environment is disclosed. The system includes a data repository configured to store metadata corresponding to a plurality of malware samples. The data repository is partitioned based on at least one attribute selected from the group consisting of submission date, threat classification, or file type. The system further includes one or more processors coupled to the data repository. The one or more processors are configured to acquire metadata from one or more data sources for a plurality of malware samples, apply a coarse filtering function to the metadata for generating a first subset of malware samples, and perform a granular selection for the first subset. The granular selection is performed by extracting one or more features from each of the plurality of malware samples in the first subset, and grouping malware samples based on similarities among the extracted features to form at least one cluster. The one or more processors are further configured to generate a second subset of malware samples from the at least one cluster representing diversity across a plurality of malware families and threat categories, and compare the second subset with a predefined threshold, indicating at least one of a minimum number of new malware samples or a target distribution of threat categories, for determining if the second subset satisfies the predefined threshold. A machine learning model is trained for malware detection using the second subset upon determining that the second subset satisfies the predefined threshold.

Other aspects and advantages of embodiments of the present invention will become apparent from the following detailed description taken in conjunction with the accompanying drawings.

### BRIEF DESCRIPTION OF THE DRAWINGS

FIG. 1 illustrates a block diagram of a system environment, in accordance with certain embodiments.

FIG. 2A a block diagram of a malware detection system configured for automated generation of training data in a malware detection environment, in accordance with certain embodiments.

FIG. 2B is a graphical representation illustrating an exemplary data selection optimization process for malware detection, in accordance with certain embodiments.

FIG. 2C is a high-level block diagram of the malware detection system, in accordance with certain embodiments.

FIG. 3 is a high-level function diagram of a malware detection system depicting the process steps of acquiring, categorizing, and utilizing malware-related data for machine learning-based malware detection, in accordance with certain embodiments.

FIG. 4 is a process flow diagram illustrating the data acquisition flow from a vendor, in accordance with certain embodiments.

FIG. 5 is a process flow diagram illustrating the step of coarse data selection to generate a first data subset, in accordance with certain embodiments.

FIG. 6 is a process flow diagram illustrating the step of file data download from a data resource, in accordance with certain embodiments.

FIG. 7A is a process flow diagram illustrating the step of performing extract, transform, and load (ETL) operations on downloaded data, in accordance with certain embodiments.

FIG. 7B is a process flow diagram illustrating a step of generating a second subset, in accordance with certain embodiments.

FIG. 8 is a process flow diagram illustrating a method for performing file data granular selection, checking data thresholds, triggering events, and initiating a machine learning (ML) training job, in accordance with certain embodiments.

FIG. 9 is a schematic diagram illustrating a step of triggering an ML training job, in accordance with certain embodiments.

FIG. 10 is a high-level block diagram illustrating the utilization of a second subset as training data for a training module of a machine learning system, in accordance with certain embodiments.

FIG. 11 is a flow diagram illustrating an exemplary implementation of automated sample data generation from an enterprise database or data warehouse, in accordance with certain embodiments.

FIG. 12 shows an example computer system that can be used to implement the malware detection system, according to certain embodiments in accordance with certain embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

### Introduction

Embodiments of the present disclosure provide an automated pipeline for generating training data in a malware detection environment. Conventional malware detection systems encounter difficulties in handling novel or evolving threats, leading to model drift and diminished detection performance. In addition, existing techniques often rely on manual curation or rule-based selection of data, which may fail to incorporate diverse malware families and can result in unbalanced or outdated training sets.

In accordance with the present disclosure, metadata associated with a plurality of malware samples is acquired and subjected to broad filtering criteria to form a first subset of malware samples. The first subset then undergoes feature extraction and clustering to produce a second subset of diverse threat samples. A threshold-based mechanism determines when the second subset contains sufficient new and varied data, triggering model retraining only upon meeting the threshold.

The present disclosure, thus, addresses frequent model updates by balancing coverage of different malware families, reducing redundant samples, and adapting to evolving threat landscapes. By integrating partitioned storage, feature-based clustering, and adaptive threshold checks, the invention renders a more efficient and scalable alternative to conventional manual or static data selection methods, mitigating model drift and enhancing the accuracy of malware detection.

### System Environment

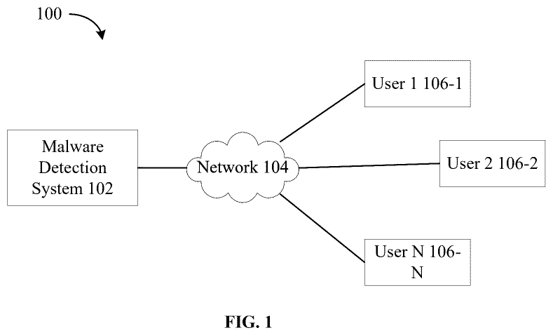

FIG. 1 is a block diagram of a system environment 100, in accordance with an embodiment. The system environment 100 comprises a malware detection system 102, a network 104, and a plurality of user devices 106-1, 106-2, through 106-N. As shown by FIG. 1, the malware detection system 102, alternatively referred to as a system 102, and the plurality of user devices 106-1 to 106-N, combinedly referred to as a user device 106, are coupled to one another through the network 104 to facilitate malware detection and analysis. In various embodiments, the environment 100 may include additional components or fewer components than those illustrated in FIG. 1. For example, multiple instances of the malware detection system 102 may extend to distributed architectures where multiple such system(s) 102 may operate across network segments or user groups, allowing for more effective handling of traffic across large-scale environments. Each instance of the system 102 in these configurations may handle data from a distinct network segment, contributing to a synchronized and collaborative approach to malware detection, resulting in enhanced overall system intelligence.

In the embodiment of FIG. 1, the malware detection system 102 identifies and classifies malware threats by processing data received from the user devices 106-1 to 106-N. The malware detection system 102 may reside within an enterprise security infrastructure (not shown), or it may operate as a self-contained security module in an endpoint device, a cloud-based security platform, or a network gateway. The malware detection system 102 is configured to apply one or more machine learning-based malware detection techniques, such as incremental analysis of incoming data packets, to predict whether a file or data stream is malicious. In one example, the malware detection system 102 extracts features from received data and compares them against a trained malware detection model to determine a likelihood of malicious content.

In one embodiment, the malware detection system 102 stores metadata related to the data it analyzes, including static attributes, such as file size or hash values, as well as behavioral indicators derived from sandbox analysis, network communication logs, or registry interactions. The malware detection system 102 may receive periodic updates to its detection model from an external source or an integrated training module (not shown), enabling continuous improvement in malware classification performance.

The network 104 may comprise any wired or wireless communication infrastructure such as the Internet, a corporate wide area network, or a cloud-based virtual network, thereby supporting various protocols and data transmission methods. The network 104 may include, but not be limited to, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. In an exemplary embodiment, the network 104 may include, but not be limited to, a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

The user devices 106-1, 106-2, through 106-N may be a type of computing entity, including personal computers, servers, mobile phones, Internet of Things (IoT) devices, or other network endpoints. When data packets are identified as potentially malicious, the malware detection system 102 may block or isolate the associated file, log the detected threat for additional forensic analysis, or transmit a notification to an administrator or an automated security response system. The malware detection system 102 may also maintain an internal repository of identified malware samples that is utilized for periodic retraining of its detection model, thereby ensuring that the model remains effective against newly emerging threats.

In alternative embodiments, the malware detection system 102 can be implemented as part of a distributed security framework, wherein multiple instances of the system environment 100 communicate and collaborate to share threat intelligence across different network segments. In such distributed arrangements, each malware detection system 102 instance may contribute locally captured data samples or refined detection analytics to a centralized repository. Such collective information enhances overall threat detection capabilities by offering a broader view of emerging mal ware variants and attack techniques. In another embodiment, the malware detection system 102 may operate in multi-tenant environments, allowing multiple customers or organizations to leverage the system's malware detection capabilities without duplicating infrastructure.

### Architecture of Malware Detection System

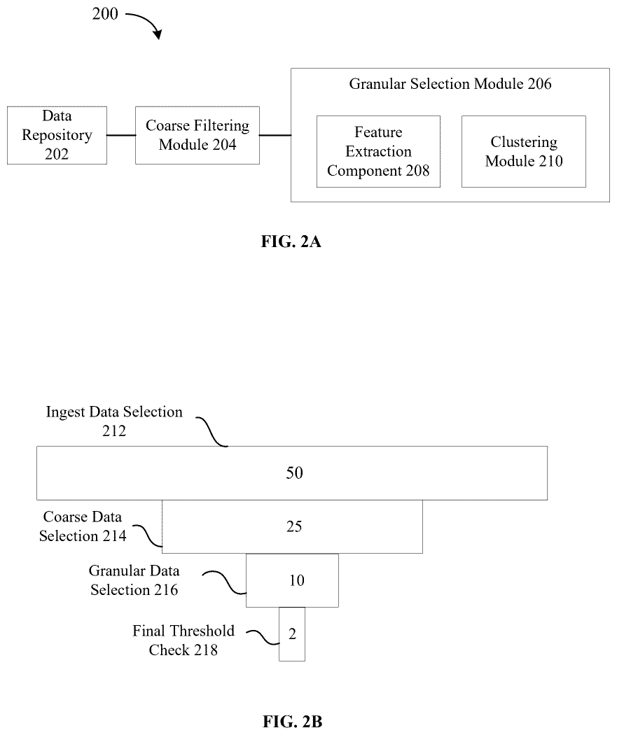

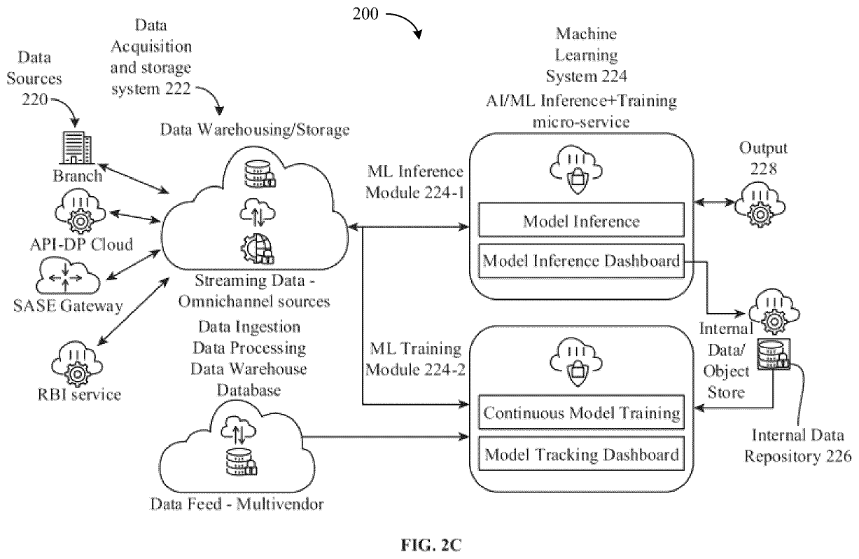

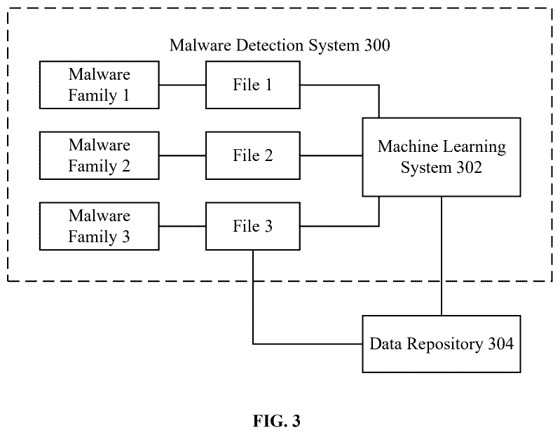

FIG. 2A is a block diagram of a malware detection system 200 configured for automated generation of training data in a malware detection environment, in accordance with an embodiment. The malware detection system 200, alternatively referred to as a system 200, mainly includes, but may not be limited to, a data repository 202, a coarse filtering module 204, and a granular selection module 206 having a feature extraction component 208 and a clustering module 210. In alternative embodiments, additional or fewer components may be present in the system 200.

In the embodiment of FIG. 2A, the data repository 202 is configured to store metadata corresponding to a plurality of malware samples that are acquired from one or more data sources. The data repository 202 may be partitioned according to submission dates, threat categories, or file attributes, thereby facilitating querying based on at least one behavioral or static file. A file identifier or a threat severity level may be included in the metadata. Examples of partitioning strategies include grouping by daily submission timestamps, categorizing malware samples by known threat families, or indexing based on file types for faster retrieval. The data repository 202 may be implemented as a relational database, a NoSQL database, an object storage system, or an in-memory data store. Examples of such implementations include SQL-based relational databases such as MySQL or PostgreSQL, document-based NoSQL databases such as MongoDB, distributed storage frameworks, such as Apache Cassandra, data warehouse solutions, such as Big Query, in-memory data structures, such as Redis, and the like. The selection of the data repository 202 may be based on query performance requirements, scalability considerations, and integration with existing security infrastructure.

The coarse filtering module 204 is configured to receive the data, corresponding to the plurality of malware samples, from the data repository 202. The coarse filtering module 204 is further configured to apply broad filtering criteria to generate a first subset of malware samples from the plurality of malware samples. In various embodiments, these broad criteria may include at least one of a threat severity level or submission date. The coarse filtering module 204 thereby excludes malware samples below a specified threshold of severity or older samples deemed less relevant to current threats. The first subset is a resultant of exclusion of low-impact malware families that do not meet minimum severity requirements.

The granular selection module 206 is configured to perform a refined filtering process on the first subset of malware samples obtained from the data repository 202. The granular selection module 206 applies refined selection criteria, such as entropy-based filtering, statistical analysis, or heuristic evaluation, to identify malware samples exhibiting unique characteristics or high deviation from known benign samples. The granular selection module 206 includes a feature extraction component 208 for extracting one or more features from each malware sample and a clustering module 210 for grouping the malware samples based on similarities among these extracted features. In an example, the feature extraction component 208 collects indicators, such as YARA rule matches, opcode distributions, or entropy measurements. The clustering module 210, in turn, groups the malware samples into at least one cluster by applying similarity-based algorithms, such as K-means, density-based or hierarchical clustering. In one aspect, dimensionality reduction may be applied prior to clustering. The resulting clusters serve to capture diverse threat categories and mitigate bias in data selection.

A second subset of malware samples is generated from the at least one cluster formed by the clustering module 210. The second subset is formed to include diversity across a plurality of malware families and threat categories. For instance, if a particular malware family is underrepresented, the system 200 may increase the proportion of samples from that family to maintain balanced distribution. In this implementation, the samples are generated based on naturally occurring data. In another implementation, a method of synthetic generation of samples may be implemented to increase the proportion of the samples. Synthetic generation refers to the process of artificially creating new data samples using algorithmic or computational methods, rather than relying solely on naturally occurring data. The second subset is subsequently compared with a predefined threshold that indicates at least one of a minimum number of new malware samples or a target distribution of threat categories. In an example, the threshold may specify that at least twenty novel samples must be included or that each selected malware family must represent at least ten percent of the second subset.

Upon determining that the second subset satisfies the predefined threshold, a machine learning model is trained for malware detection using the second subset. If the threshold is not satisfied, the coarse filtering module 204, the granular selection module 206, or both may be dynamically adjusted. The predefined threshold may be modified in response to suboptimal performance metrics such as accuracy or recall. The data repository 202 may retain a record of each subset for version control or for monitoring redundancy. In some embodiments, a scheduling mechanism automatically repeats the steps of acquiring metadata, applying the coarse filtering function, performing granular selection, generating the second subset, and comparing the second subset to the threshold at predetermined intervals or upon detecting at least one trigger event.

FIG. 2B is a graphical representation illustrating an exemplary data selection optimization process for malware detection, in accordance with an embodiment. In the embodiment of FIG. 2B, an ingest data selection stage 212 is initially performed to acquire approximately fifty million data samples, including raw malware samples obtained from multiple sources, such as threat intelligence feeds, honeypots, and security research databases. These samples may include metadata, behavioral attributes, and execution traces relevant to identifying potential malicious activity.

Following the ingest data selection stage 212, a coarse data selection stage 214 is applied to reduce the dataset to approximately twenty-five million samples. During the coarse data selection stage 214, broad filtering criteria are implemented to remove redundant or low-priority samples while retaining data points that meet defined selection thresholds. Such thresholds may be based on file type classifications, threat severity levels, or submission dates.

After completion of the coarse data selection stage 214, a granular data selection stage 216 is performed to further optimize the dataset, resulting in approximately ten million samples. In various embodiments, the granular data selection stage 216 is based on feature-based analysis, clustering techniques, or correlation with known malware signatures to represent multiple malware families and threat categories. The granular data selection stage 216, thus, refines the dataset such that it maintains sufficient diversity and coverage of threats.

Subsequently, a final threshold check stage 218 is applied to yield a refined dataset of approximately two million samples. The final threshold check stage 218 evaluates the most relevant and diverse samples according to considerations, such as representation of novel malware types, distribution across threat categories, and sufficiency for effectively training a machine learning model. In one example, the samples selected at the final threshold check stage 218, thus, retains an appropriate balance between new threat variants and historically observed malware families.

FIG. 2C is a high-level block diagram of the malware detection system 200. The malware detection system 200 include data sources 220, a data acquisition and storage system 222, a machine learning system 224, an internal data repository 226, and an output module 228 for malware detection. As illustrated, the data sources 220 provide streaming data from external and internal sources, including, but may not be limited to, threat intelligence feeds, endpoint security logs, cloud security services, and malware analysis platforms. This configuration allows the system 200 to incorporate both structured and unstructured security data.

In the system 200, the data acquisition and storage system 222 is configured to collect and process large volumes of data received from data sources 220. The data acquisition and storage system 222 is described in conjunction with FIG. 2A as a data repository 202. The data acquisition and storage system 222 applies data normalization and deduplication procedures before storing information for subsequent machine learning operations.

The machine learning system 224 is configured to perform model training and inference for malware detection. The machine learning system 224 includes an inference module 224-1 that applies pre-trained models to classify potential threats in near real time. The machine learning system 224 also includes a training module 224-2 that refines model parameters based on selected malware datasets and model performance outcomes.

In one example, the data acquisition and storage system 222 receives logs from a cloud security service via data sources 220, and the machine learning system 224 evaluates those logs in the inference module 224-1 for immediate threat identification. In another example, the training module 224-2 applies clustering techniques to selected malware samples stored in the internal data repository 226 and updates a machine learning model used by the inference module 224-1. The output module 228 transmits notifications regarding detected threats and model performance statistics to an enterprise security console. This arrangement is adaptable to environments that require automated workflows and continuous updates for malware detection.

### Malware Sample Data Utilization for Malware Detection

FIG. 3 is a high-level function diagram of a malware detection system 300 depicting the process steps of acquiring, categorizing, and utilizing malware-related data for machine learning-based malware detection, in accordance with an embodiment. The malware detection system 300 is a representation of the malware detection system 200 of FIG. 2A and FIG. 2C. As illustrated, the malware detection system 300 is operatively connected to a data repository 304, which maintains metadata associated with multiple malware families. The malware detection system 300 communicates with the data repository 304 to access or update information related to each malware sample.

The malware detection system 300 processes malware families that each include multiple files containing relevant malware characteristics. For example, Malware Family 1, Malware Family 2, and Malware Family 3 may each contain File 1, File 2, and File 3. These files represent distinct variants of malicious software and are stored in the data repository 304 along with attributes such as file signatures, hash values, and execution behaviors. The malware detection system 300 is configured to retrieve the stored attributes to classify and organize these malware samples.

Ordinarily, the data repository 304 maintains structured metadata for querying and retrieval by the malware detection system 300. In the embodiment of FIG. 3, the machine learning system 302 interacts with the data repository 304 to extract features and utilize those features in a training process, thereby refining a malware detection model. The machine learning system 302 applies techniques such as clustering or classification to identify relationships among malware families, and the system 300 is capable of adapting to new threats by incorporating additional samples when they become available. The malware detection system 300 is configured to prevent bias in the generated model. By distributing malware samples across multiple malware families and threat types, the system 300 ensures that varying threat categories are represented. The machine learning system 302 may apply algorithms such as K-means clustering, hierarchical clustering, or density-based clustering to categorize the samples and improve detection accuracy. This arrangement reduces the likelihood of misclassification arising from overrepresentation of a single threat type.

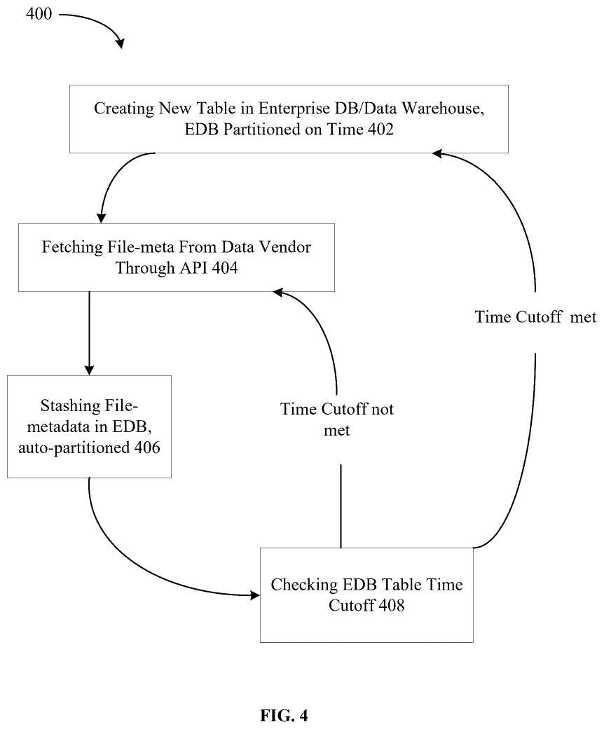

FIG. 3 depicts the sample data being utilized for training the machine learning system 302, whereas FIG. 4 depicts a detailed process flow of the sample data acquisition flow from a vendor which is optimized and then fed to the machine learning system 302.

### Data Acquisition

FIG. 4 is a process flow diagram illustrating a data acquisition flow from a vendor, in accordance with an embodiment. The process 400 is performed by the malware detection system 200 as illustrated by FIG. 2A and FIG. 2C. The process 400 initiates with the creation of a new table in an enterprise database (EDB) at step 402. The EDB, which is a representation of the data repository 202 of FIG. 2A, is configured as a partitioned storage system to enable efficient retrieval and classification of malware metadata. The partitioning structure allows for optimized storage and ensures that the acquired data is organized based on predefined parameters. The EDB is partitioned based on time, rendering efficient organization and retrieval of malware samples. The time-based partitioning mechanism is configured to structure the ingestion of data chronologically, allowing for streamlined access and reducing data redundancy. The partitioning strategy supports scalable data management so that the historical and real-time malware metadata are efficiently categorized for subsequent processing.

At step 404, file metadata is fetched from a vendor via an application programming interface (API). The metadata may include file hashes, timestamps, file types, behavioral indicators, and threat classification labels. The API-based data retrieval mechanism is designed to automate the ingestion process, ensuring that large volumes of malware-related data can be acquired without manual intervention. The metadata fetched from the vendor is structured in accordance with predefined data schemas to facilitate seamless integration with the EDB.

At step 406, the system stores the acquired file metadata in the EDB. Upon storage, the metadata is automatically partitioned based on predefined classification attributes, ensuring efficient data retrieval for future analysis. The structured storage methodology ensures that malware samples are efficiently categorized, thereby supporting high-speed query execution and scalable dataset management.

At step 408, a time cutoff evaluation is performed to determine whether the acquired dataset satisfies predefined ingestion thresholds. The time cutoff condition assesses whether the retrieved malware sample metadata aligns with the latest batch of malware data required for further processing. If the time cutoff condition is not met, the system continues fetching additional metadata from the vendor. The acquisition process iterates until the time threshold is satisfied, ensuring that only the most relevant and recent malware samples are retained for processing.

If the time cutoff condition is met, the system proceeds to further stages of data selection, transformation, and malware analysis. The transition to the subsequent stages ensures that the selected data is appropriately processed before being used for machine learning-based malware detection. The ingestion pipeline is configured to handle large-scale data processing, ensuring that malware datasets are optimized for training and inference applications.

In some embodiments, the data acquisition flow includes adaptive thresholding mechanisms that dynamically adjust the selection criteria based on real-time data inputs. The adaptive thresholding process ensures that high-priority malware samples are prioritized for analysis, thereby improving the accuracy of malware detection models. The data acquisition framework may further incorporate real-time validation checks to ensure the integrity and reliability of the retrieved data before it is stored in the EDB.

In various embodiments, the data acquisition flow supports integration with multiple vendor sources, enabling ingestion from diverse external datasets. The system architecture is configured to manage API-based data retrieval from multiple third-party security platforms for comprehensive coverage of malware threats. The system may also integrate with distributed data pipelines to facilitate cloud-based data ingestion and scalable malware analysis.

In some configurations, the data acquisition pipeline incorporates automated anomaly detection mechanisms that filter out low-relevance or redundant data before it is stored. The anomaly detection framework ensures that only high-quality malware samples are processed, thereby enhancing the overall efficiency of the malware detection system. In alternative embodiments, the data ingestion flow includes automated enrichment mechanisms that append additional contextual information to the retrieved malware samples.

In additional configurations, the system may include cloud-based storage solutions, distributed security analytics platforms, and machine learning-driven threat intelligence integration. The data acquisition pipeline may be further extended to support automated remediation workflows, where threat intelligence data is used to proactively identify and mitigate emerging malware risks before they propagate within enterprise networks.

### Coarse Data Selection and First Subset Generation

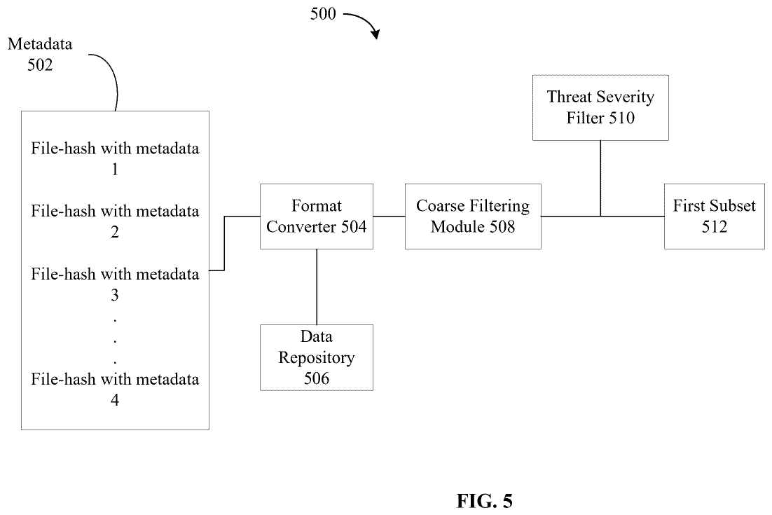

FIG. 5 is a process flow diagram illustrating the step of coarse data selection to generate a first data subset, in accordance with an embodiment. The process 500 is performed by the malware detection system 200 as illustrated by FIG. 2A and FIG. 2C. The process 500 initiates with acquiring metadata 502 associated with a plurality of files intended for training a machine learning model for malware detection. Each of the plurality of the files may be received in a form of a file hash with metadata. For example, a file-hash with metadata 1, a file-hash with metadata 2, a file-hash with metadata 3, a file-hash with metadata 4, and so on. The metadata includes, but may not be limited to, file attributes such as file hashes, timestamps, file types, behavioral indicators, and threat classification labels.

The acquired metadata 502 is then processed through a format converter 504. The format converter 504 is a component that standardizes the metadata format to enable compatibility with downstream processing modules. The standardization is performed so that metadata fields are aligned with predefined schemas used for selection and classification.

The formatted metadata is then stored in a data repository 506. The data repository 506 is a representation of the data repository 202 of FIG. 2A. The data repository 506 is configured to maintain structured metadata for malware samples for efficient querying and retrieval for further processing. The repository is partitioned based on predefined attributes, such as submission date, threat category, and file type.

A coarse filtration is then applied on the metadata by a coarse filtering module 508. The coarse filtering module 508 is configured to apply broad selection criteria to generate an initial subset of malware samples. The selection criteria may include filtering the metadata according to the parameters, such as file type, threat category, submission date, and known indicators of compromise. The coarse filtering module 508 may also reduce the dataset size even while representing the diverse malware families.

A threat severity level check is performed by a threat severity filter 510 to further refine the selected dataset. The check threat severity level module 510 evaluates whether the selected malware samples meet a predefined threshold for threat severity. Samples that do not meet the threshold are excluded from further processing. The severity level check is performed so that the dataset used for training includes files that pose a significant security risk.

The refined set of malware samples, referred to as a first subset 512, is generated based on evaluation of the threat severity level of the malware samples. The first subset 512 thus comprises malware samples that have been filtered based on broad selection criteria and validated for threat severity. The first subset 512 is subsequently processed in later stages for granular selection and feature extraction before being used for model training.

In some embodiments, the coarse data selection process integrates adaptive selection criteria that dynamically adjust based on real-time threat intelligence inputs. The adaptive selection caters to the emerging malware trends. The data selection pipeline may further incorporate automated anomaly detection mechanisms to identify and exclude outlier samples that do not conform to expected threat patterns.

In various embodiments, the coarse data selection framework is implemented as part of a larger data pipeline for machine learning-based malware detection. The framework may include cloud-based storage solutions, distributed data processing systems, and security analytics platforms to enhance scalability and efficiency. Alternative configurations may integrate with external threat intelligence feeds and sandbox analysis systems.

Data Downloading from Data Resources

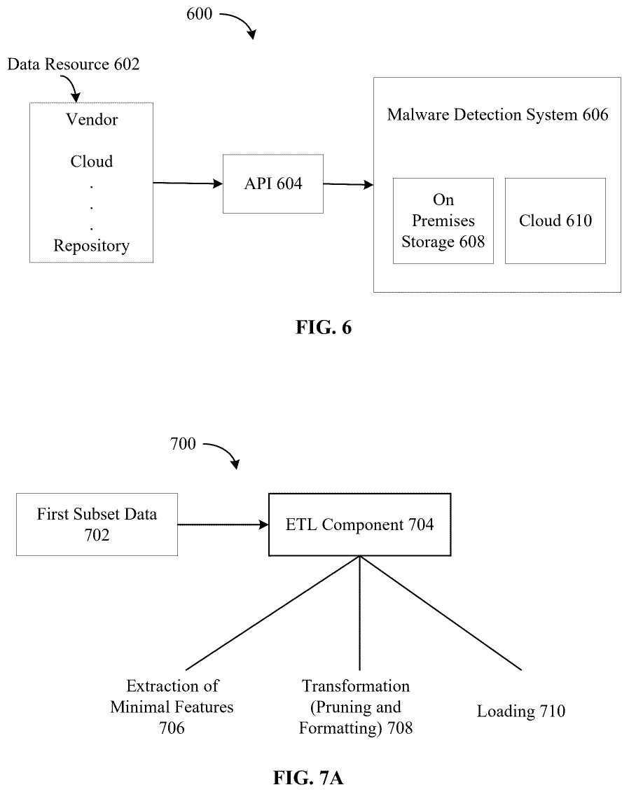

FIG. 6 is a process flow diagram illustrating the step of file data download from a data resource, in accordance with an embodiment. The process 600 is performed by the malware detection system 200 as illustrated by FIG. 2A and FIG. 2C. The process 600 initiates with retrieving a data from a data resource 602, such as a vendor premises, cloud, or data repository. The data comprises malware-related files and metadata that are selected based on prior filtering and selection processes. The retrieval process is performed using an application programming interface (API) 604 configured to interact with cloud-based storage systems.

Upon retrieving the data, an API request is issued, by the API 604, to the data resource 602 to initiate the download process. The API 604 is configured to authenticate the request and retrieve the selected dataset from the data resource 602. The API request may include parameters, such as file identifiers, metadata attributes, and security credentials to ensure that the requested dataset is accurately retrieved. The API 604 further supports batch retrieval mechanisms to enable efficient downloading of large datasets.

The retrieved dataset is then processed by the malware detection system 606. The malware detection system 606 is configured to verify the integrity of the downloaded files and ensure that the dataset aligns with predefined selection criteria. The malware detection system 606 may perform preliminary checks, such as validating file hashes, confirming file types, and assessing metadata consistency before storing the dataset.

At 608, the downloaded dataset is stored in an on-premises storage system 608. The on-premises storage system 608 is configured as a local repository for securely maintaining malware-related files. The storage system may implement access control mechanisms, encryption protocols, and backup procedures to ensure the security and availability of the dataset. The on-premises storage system 608 allows for rapid access and processing of malware samples for further analysis and training.

At 610, an alternative storage destination is identified as a cloud storage system 610. The cloud storage system 610 is configured to maintain malware-related datasets in a distributed storage environment. The cloud storage system 610 enables scalable storage and remote access to the dataset, facilitating integration with cloud-based malware detection frameworks.

In some embodiments, the file data download process includes automated validation mechanisms that assess the quality and completeness of the retrieved dataset. The validation process ensures that all files are successfully downloaded, metadata attributes are correctly mapped, and potential data corruption issues are identified. The validation framework may further incorporate redundancy checks and error correction mechanisms to enhance data reliability.

In various embodiments, the file data download pipeline supports integration with multiple vendor sources, enabling ingestion from diverse threat intelligence providers. The system architecture is designed to handle concurrent data requests, ensuring that malware samples from different vendors are aggregated efficiently. The pipeline may also include scheduling mechanisms that trigger periodic downloads based on predefined update intervals or real-time threat intelligence inputs.

In alternative configurations, the system supports adaptive data retrieval mechanisms that prioritize high-risk malware samples for immediate processing. The adaptive retrieval process may utilize real-time threat scoring and anomaly detection techniques to dynamically adjust the selection criteria for file downloads.

### Granular Data Selection by Performing ETL Operations

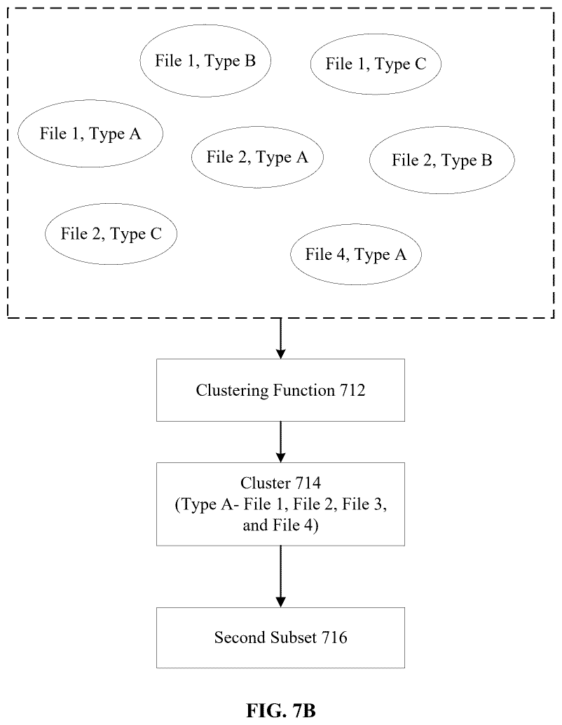

FIG. 7A is a process flow diagram illustrating the step of performing extract, transform, and load (ETL) operations on downloaded data, in accordance with an embodiment. The process 700 is performed by the malware detection system 200 as illustrated by FIG. 2A and FIG. 2C. The process 700 initiates with receiving a first subset of data 702 which comprises selected malware-related files and associated metadata. The first subset of data 702 is retrieved from storage following the data acquisition and selection processes described in previous figures.

The first subset of data 702 is processed by an ETL component 704. The ETL component 704 is configured to extract relevant features from the downloaded dataset maintaining that only the necessary attributes are retained for subsequent analysis. The extracted features include, but are not limited to, static file properties, behavioral characteristics, and threat classification attributes. The extraction process is optimized to minimize computational overhead while maintaining the integrity of the malware dataset.

The extracted features are subjected to a transformation process comprising pruning and formatting operations. The transformation process removes redundant or non-contributory attributes that do not enhance the malware detection model's learning process. In addition, the transformation process normalizes the extracted data to ensure consistency across different malware samples. The pruning and formatting operations are tailored to align with predefined standards for feature representation, ensuring compatibility with downstream machine learning workflows.

The transformed data is processed into a structured format suitable for further analysis and modeling. The formatted dataset is structured to facilitate efficient ingestion into subsequent machine learning pipelines. The data may be formatted into tabular structures, hierarchical data models, or distributed frameworks such as Apache Dask and Apache Spark to enable large-scale processing. The structuring process ensures that the extracted and transformed data is efficiently accessible for granular selection and model training.

The processed dataset is then loaded into a storage repository, making it available for the next phase of the data pipeline. The storage repository may be a centralized data warehouse, a distributed storage system, or an on-premises server optimized for malware analysis. The loading process ensures that the structured data is indexed and cataloged for efficient querying and retrieval. The storage repository further supports versioning mechanisms to track updates in the dataset over time, facilitating reproducibility and traceability in malware detection workflows.

In some embodiments, the ETL pipeline is configured to adaptively adjust feature extraction and transformation parameters based on historical model performance. The system may incorporate feedback mechanisms that analyze model outcomes and dynamically refine the feature selection criteria. Such adaptive mechanisms enhance the quality of the dataset used for training malware detection models, improving overall detection efficacy.

In alternative configurations, the ETL pipeline includes integration with external data sources to supplement the extracted features with additional threat intelligence. These integrations may involve real-time enrichment from security feeds, domain reputation services, and threat intelligence platforms. The ETL pipeline further incorporates logging and monitoring components to track the completeness and quality of processed data, ensuring adherence to predefined selection thresholds.

In various embodiments, the ETL component 704 supports parallel processing techniques to optimize data transformation efficiency. The parallel execution of feature extraction and transformation tasks enhances processing speed, reducing latency in preparing the dataset for subsequent analysis.

### Second Subset Generation

FIG. 7B is a process flow diagram illustrating a step of generating a second subset, in accordance with an embodiment. The process 700 is performed by the malware detection system 200 as illustrated by FIG. 2A and FIG. 2C. The process 700 begins with categorizing downloaded files based on their respective file types, wherein each file is grouped according to predefined categories for further processing. In an examples, there may be Type A, Type B, and Type C of the files. For each type, a plurality of files may be downloaded, such as File 1, File 2, and File 3 for Type A, File 1, File 2, and File 3 for Type B, and so on.

At step 712, a clustering function is applied to the downloaded files to classify them into meaningful clusters. The clustering function 712 groups the files based on extracted attributes, which may include, but are not limited to, file format, behavioral characteristics, and structural properties. The clustering function ensures that similar types of malware files are grouped together, facilitating effective sample selection for model training.

At step 714, a cluster 714 is formed, comprising files belonging to a specific type. For instance, as depicted in FIG. 7B, a cluster 714 may include multiple files of Type A, specifically File 1, File 2, File 3, and File 4. This clustering operation optimizes the process of malware detection by ensuring that files with similar attributes are processed together, thereby reducing redundancy and enhancing training efficiency.

At step 716, the second subset is generated by selecting representative samples from the identified clusters. The selection process is designed to maximize diversity within the second subset 716 while minimizing redundancy. The selection criteria may be based on statistical measures, distribution patterns, and thresholds to ensure a well-balanced training dataset. The generated second subset represents the refined dataset that is subsequently used in downstream machine learning tasks, including model training and validation.

In some embodiments, the clustering function 712 incorporates dimensionality reduction techniques such as Principal Component Analysis (PCA) or Uniform Manifold Approximation and Projection (UMAP) to enhance the efficiency of feature selection. These techniques reduce the complexity of high-dimensional malware datasets while retaining critical discriminatory features.

In various embodiments, the second subset is dynamically updated based on historical model performance metrics. The system continuously evaluates the effectiveness of selected samples and refines the selection process based on feedback from previous training iterations. Because of such adaptive mechanism, the training dataset remains representative of the evolving malware landscape. In further embodiments, the clustered data is stored in a partitioned repository for efficient querying and retrieval for future analysis.

### Directed Acrylic Graph

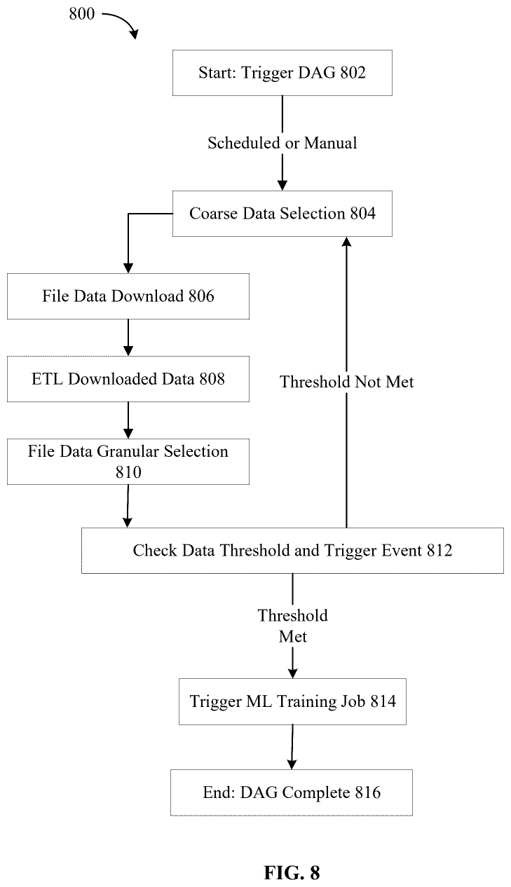

FIG. 8 is a process flow diagram illustrating a method for performing file data granular selection, checking data thresholds, triggering events, and initiating a machine learning (ML) training job, in accordance with an embodiment. The process 800 is performed by the malware detection system 200 as illustrated by FIG. 2A and FIG. 2C. The process 800 initiates at step 802, where a Directed Acyclic Graph (DAG) is triggered either manually or based on a predefined schedule. At step 804, a coarse data selection is performed. At step 806, file data is downloaded from a vendor cloud storage or other designated data source. The downloaded file data is subsequently processed, at step 808, where an ETL (Extract, Transform, Load) operation is performed to extract minimal features from the downloaded data based on the file type. The ETL process further includes pruning and formatting the extracted features to prepare them for subsequent processing.

At step 810, a granular data selection operation is performed on the extracted and formatted data. The granular data selection process involves identifying and clustering data samples based on predefined selection criteria, including threat category, malware type, and file attributes. The selection is performed to include a diverse set of representative malware samples in the final dataset to avoid model bias and ensure adaptability to evolving threats. At step 812, the system 200 evaluates whether a predefined data threshold is met. If the threshold is not met, the process 800 returns to step 804 for additional data selection and acquisition. If the threshold is met, the process proceeds to step 814, where an ML training job is triggered. The ML training process involves feeding the selected and processed data into a machine learning system to train an updated malware detection model.

At step 816, the DAG process is completed, marking the end of the workflow execution. Throughout the process, various operational parameters are logged, including the volume of selected data, model performance metrics, and threshold validation results. These logs serve as inputs for optimizing future data selection and training cycles.

In various embodiments, the coarse data selection, at step 804, may be performed using broad filtering criteria such as submission date, file type, and threat severity level. The file data download, at step 806, may involve retrieving files from cloud-based threat intelligence feeds or on-premises storage repositories. The ETL operation, at step 808, may include data transformation techniques, such as dimensionality reduction, clustering, and feature normalization. The granular data selection, at step 810, may incorporate machine learning-based clustering techniques, such as K-means or hierarchical clustering, to optimize the selection of training samples. The threshold validation, at step 812, ensures that the selected data set maintains diversity across different malware families and threat categories.

The ML training job, at step 814, may be configured to execute using a distributed training framework, allowing scalability across multiple processing units. The training process includes monitoring key performance indicators, such as precision, recall, and false-positive rates to ensure optimal detection accuracy. Upon completion of the DAG process, at step 816, the trained model is deployed within a malware detection system 200 to improve real-time threat detection capabilities.

Alternative configurations may include additional data selection steps, model validation checkpoints, or integration with external security analytics platforms to enhance malware detection effectiveness. The embodiments described herein can be adapted to various AI-driven cybersecurity systems requiring continuous training and optimization.

### Triggering Events and Machine Learning Initiation

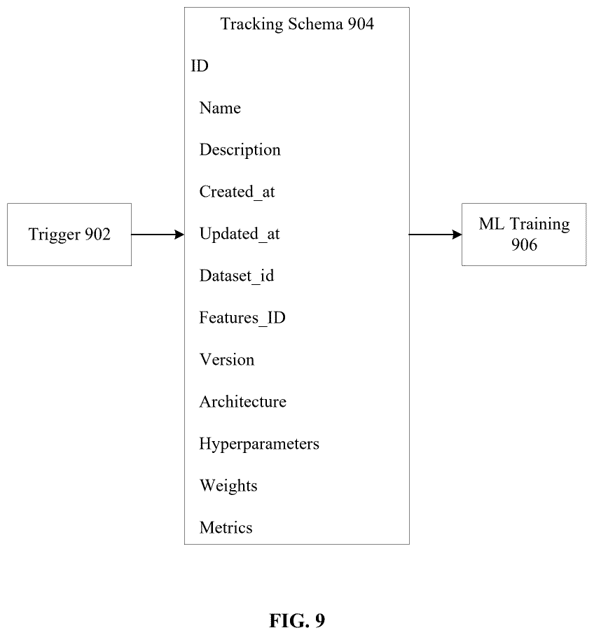

FIG. 9 is a schematic diagram illustrating a step of triggering an ML training job, in accordance with an embodiment. The process depicted in FIG. 9 initiates the ML training pipeline based on a predefined trigger 902. The trigger 902 may be activated based on a scheduled event, a manual input, or a dynamically determined condition associated with data accumulation and preprocessing thresholds. Upon activation, the process enters a stage of recording and managing training metadata via a tracking schema 904.

The tracking schema 904 maintains structured metadata associated with the ML training process. The structured metadata includes, but is not limited to, an identifier (ID), a name, a description, a creation timestamp, an update timestamp, a dataset identifier, a features identifier, a version number, an architecture specification, hyperparameters, model weights, and evaluation metrics. These metadata elements enable systematic tracking of training experiments and facilitate reproducibility in subsequent model iterations.

Following the metadata registration, the ML training process is executed within the ML training module 906. The ML training module 906 processes the dataset identified in the tracking schema 904, applies the associated feature set, and utilizes the specified hyperparameters for model optimization. In various embodiments, the ML training module 906 may implement supervised learning, unsupervised learning, or reinforcement learning methodologies to enhance model performance.

Upon completion of the ML training process, the trained model undergoes evaluation based on predetermined performance metrics, which may include accuracy, precision, recall, F1-score, and area under the curve (AUC) values. The evaluation results are stored in the tracking schema 904 for reference in future training iterations and model comparisons.

The ML training module 906 may be configured to trigger further downstream processes, including model deployment, inference validation, and retraining cycles, based on the recorded performance metrics. In one embodiment, if the trained model meets or exceeds a predefined performance threshold, it is automatically scheduled for deployment in a production environment. Conversely, if the performance metrics fall below an acceptable range, the ML training module 906 may initiate additional training iterations with hyperparameter adjustments or alternative data selections.

### Machine Learning Training and Inference Phases

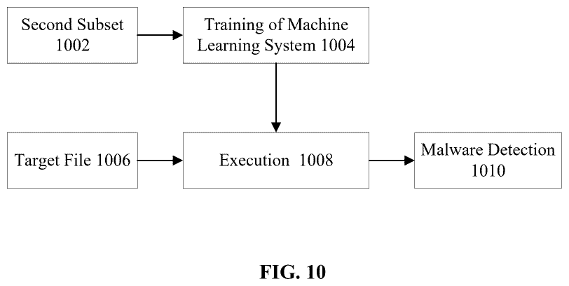

FIG. 10 is a high-level block diagram illustrating the utilization of a second subset as training data for a training module of a machine learning system, and the processing of a target file by an inference module for malware detection, in accordance with an embodiment. The process depicted in FIG. 10 is initiated based on the ML training job triggered in FIG. 9, where an ML training pipeline is executed using selected training data and tracked using an experiment tracking schema.

As shown in FIG. 10, a second subset 1002, generated through the data selection and ETL processes described in previous figures, is provided to the training module of a machine learning system 1004. The machine learning system 1004 is configured to optimize model parameters based on the second subset 1002, ensuring adaptability to evolving threat patterns. The training of the machine learning system 1004 follows the ML training pipeline described in FIG. 9, where metadata related to training iterations, hyperparameters, dataset versions, and model performance metrics are recorded and managed using the tracking schema.

Once the training phase is complete, the trained model is deployed to an inference module of the machine learning system. The inference module receives a target file 1006, which is subject to analysis based on the trained model. The inference module executes 1008 the trained model on the target file 1006 to determine whether the file exhibits characteristics indicative of malware. The execution 1008 process leverages the experiment tracking schema described in FIG. 9, ensuring consistency in model versioning, feature extraction methodologies, and evaluation metrics.

The execution 1008 process culminates in a malware detection system 1010 making a final determination regarding the maliciousness of the target file 1006. The malware detection system 1010 classifies the target file 1006 as either benign or malicious based on predefined threshold parameters. If the malware detection system 1010 identifies the file as malicious, additional mitigation actions may be performed, such as quarantining the file, alerting security teams, or blocking the associated network communication.

In some embodiments, the training of the machine learning system 1004 is performed continuously as part of an automated retraining pipeline linked to the ML training job described in FIG. 9. The second subset 1002 is periodically updated based on new data sources and selection criteria, ensuring that the machine learning system 1004 remains effective against emerging threats. The target file 1006 may be sourced from network traffic, endpoint devices, or external repositories, and the execution 1008 of the inference module may be performed in real-time or in batch processing mode, depending on system configurations.

Alternative embodiments may include additional or different components within the machine learning system 1004, such as an adversarial learning module to improve robustness against obfuscation techniques, or a feedback loop mechanism to refine the training dataset based on false positives and false negatives observed in production deployments. The ML training may incorporate automated threshold adjustments to improve detection accuracy and reduce false positive rates.

### Detailed Process of Automated Generation of the Training Data

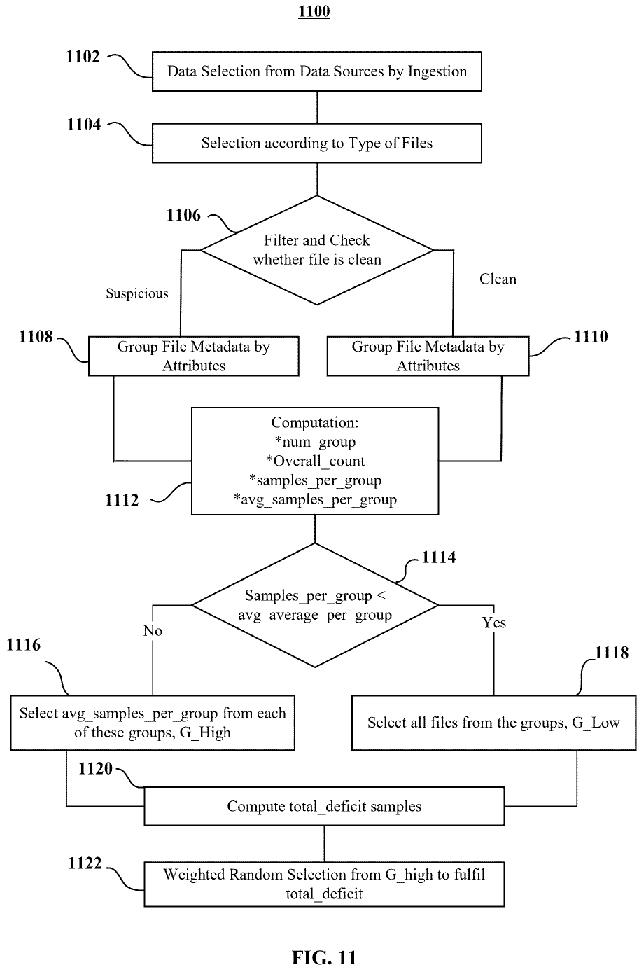

FIG. 11 is a flow diagram illustrating an exemplary implementation of automated sample data generation from an enterprise database or data warehouse, in accordance with an embodiment. At step 1102, an ingestion module selects data from one or more data sources. An initial filtering and validation process is performed on the selected data, at step 1104.

At step 1106, the selected data is assessed to determine whether the file is classified as clean or suspicious. The selected data is then systematically grouped based on file metadata attributes, which may include, but are not limited to, submission date, file size, threat classification, and sample type. The grouped file metadata is subsequently categorized as malicious or suspicious, in accordance with predefined selection criteria of malicious or suspicious data, at step 1108. The grouped file metadata is also categorized as clean, in accordance with predefined selection criteria of clean data, at step 1110.

At step 1112, computational operations are executed to determine the total number of identified groups, the overall sample count, and the average number of samples per group. An evaluation is performed to determine whether the number of samples within each group falls below the computed average sample count per group. The computation is performed using following equations.

$$Num\_groups ( {N}_{g} ) = Count ( G ) \qquad ( 1 )$$

where G=Group (submission_date, size, threat_type, sample-type)

Equation (1) defines the number of groups (N_{g}) in which the malware samples are categorized. The groups are formed based on the attributes, such as submission date, file size, threat type, and sample type. The function Count (G) represents the total number of identified groups.

$$Avg\_samples \_per \_group ( {N}_{ag} ) = CumSum ( G ) / {N}_{g} , \qquad ( 2 )$$

where CumSum

$$( G ) = {\sum }_{i = 0}^{{N}_{g}} {g}_{i} .$$

here gᵢ is the number of samples in group i.

Average number of samples per group (N_{ag}) is determined by Equation (2).

At step 1114, a number of samples per group is compared with a number of average samples per group. If the number of samples is larger than the number of average samples per group, files, at least in a number matching to the number of average samples per group, are selected from the high-priority groups, at step 1116. The files, exceeding the number of average samples per groups may be omitted. At step 1118, if the number of samples is smaller than the number of average samples per group, all files from the group are selected from the lower-priority groups.

At step 1120, a computation is performed to determine the total number of deficit samples required to achieve dataset equilibrium.

$${D}_{k} = \{ \begin{matrix}{N}_{ag} - {g}_{k} \overline{ι f} {g}_{k} < {N}_{ag} , else \\ 0\end{matrix} \qquad ( 3 )$$

where gₖ is samples in group k.
Dₖ represents the deficit for each group. If a group gₖ has fewer samples than the average N_{ag}, the difference N_{ag}−gₖ is recorded as a deficit. Else, if the group already has equal or more samples than N_{ag}, the deficit is set to zero.

$$( {T}_{d} ) = {\sum }_{i = 0}^{{N}_{g}} {D}_{i} \qquad ( 4 )$$

Equation (4) computes the total deficit (T_{d}) across all groups. Total deficit is sum of the individual deficits (Dᵢ) of all groups.

At step 1122, a weighted random selection is applied to the high-priority group to compensate for the identified deficit. This selection mechanism ensures that an optimal distribution of data is maintained across different categories for subsequent analytical processing.

$$( {S}_{i} ) = \{ \begin{matrix}rand ( {w}_{i} * ( {g}_{i} - {N}_{ag} ) ) , if {g}_{i} > {N}_{ag} , else \\ 0\end{matrix} \qquad ( 5 )$$

Equation (5) implements a weighted random selection process to compensate for the total deficit.

$${T}_{d} = {\sum }_{i = 0}^{{N}_{g}} {S}_{i} \qquad ( 6 )$$

Equation (6) computes the total re-selected samples for compensating the total deficit T_{d} from underrepresented groups.

As a result, the data is applied with a final classification, wherein the data is categorized as either “suspicious” or “clean” based on the metadata attributes and analytical assessment corresponding to the data. The selected dataset is then forwarded for further refinement and subsequent use in downstream data processing pipelines, facilitating integration of the selected dataset into machine learning model training and inference workflows.

Equation (1) through Equation (6) relate to the coarse selection of the samples. The granular selection of samples (not shown in FIG. 11), in one aspect, is performed by using following equations.

$${X}_{s c a l e d} = Min max Scaler ( X ) \qquad ( 7 )$$

Equation (7) computes scaling of the feature data. The feature data X is assumed to the in a high-dimensional space R^{mnl}, where m is the number of samples, n is the number of features, and/is the depth of data representation.

$${E}_{{X}_{s c a l e d}} = UMAP ( {X}_{s c a l e d} ) \qquad ( 8 )$$

Equation (8) represents the dimensionality reduction using Uniform Manifold Approximation and Projection. The normalized dataset X_{scaled} is transformed using UMAP. UMAP is a technique that projects high-dimensional data into a lower-dimensional space while preserving structural relationships.

Further, the optimal number of clusters is identified. In one embodiment of the present disclosure, an Elbow method is used for identifying the optimal number.

$$C = [ c 1 , c 2 , c 3 , … , c - k ] for data {X}_{s c a l e d} ∈ {R}_{m n l} \qquad ( 9 )$$

Equation (9) defines a set of potential cluster numbers.

K-means clustering is applied for each cluster size j, as shown in Equation (10):

$${K}_{m} = KMeans ( j ) \cdot fit ( X ) \qquad ( 10 )$$

Then, a sum of squared distances (SSD) is computed by using Equation (11):

$$SD = intertia ( {k}_{i} ) for all {k}_{i} in {K}_{m} \qquad ( 11 )$$

Further, the cluster lables are plotted by using Equation (12):

$${L}_{c} = KMeans ( j ) \cdot fit\_predict ( X ) \qquad ( 12 )$$

Once the cluster labels are plotted, a significant drop in SSD (from centroid) across all the labels L_{c} can be taken as the approximate number of clusters to optimize. Let's say,

$${A}_{{L}_{c}} = Approximate clusters from elbow method$$

In one aspect, the density-based clustering is applied using HDBSCAN, as given in Equation (13):

$${H}_{{L}_{c}} = HDBSCAN \cdot fit ( {A}_{{L}_{c}} , {E}_{{X}_{scaled}} ) \qquad ( 13 )$$

HDBSCAN is applied to the transformed feature space E_{X}_{_{scaled}} using the cluster approximation from the elbow method. HDBSCAN assign cluster labels H_{L}_{_{c}}, where, H_{c}=(H_{L}_{_{c}}≥0), where H_{L}_{_{c}}={l₁, l₂, l₃, l₄, l₅, . . . , l_{q}}, here lᵢ are non-distinct

The cluster labels and corresponding sample counts are obtained by using Equation (14):

$${N}_{{H}_{c}} = \{ ( {l}_{1} , {c}_{1} ) , ( {l}_{2} , {c}_{2} ) , … , ( {l}_{p} , {c}_{p} ) \} \qquad ( 14 )$$

where, p represents the number of clusters, lᵢ represents each cluster label, and cᵢ is the number of samples in that cluster.

Further, cluster distribution is computed by using Equation (15).

$${l}_{pct} = \frac{{N}_{{H}_{c}} [ 1 ]}{{H}_{c}} \qquad ( 15 )$$

Where, N_{H}_{_{c}}[1] represents count vector, l_{pct} represents frequency % vector.

Noise samples are identified by using Equation (16).

$${H}_{N C} = ( {H}_{{L}_{c}} < 0 ) \qquad ( 16 )$$

where H_{NC} represents an unclustered component or a noise component. Samples that do not belong to any cluster are labeled as noise.

Final sample selection for training is determined by Equation (17).

$${N}_{train} = Select ( {H}_{c} , {N}_{{H}_{c}} , {l}_{pct} , rand ( seed ) ) ⋃ {H}_{NC} \qquad ( 17 )$$

The final training dataset is generated by randomly selecting samples from clusters based on the respective distribution l_{pct}. The selection criteria can be enhanced to be multi-parameter, such as size, observation, frequency and the like.

### Computer Architecture

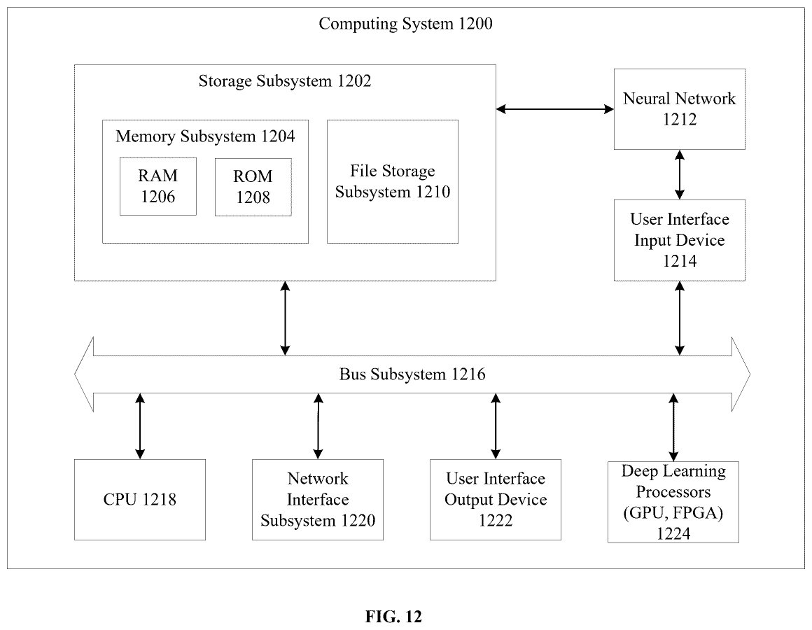

FIG. 12 shows an example computer system 1200 that can be used to implement the technology disclosed. The computer system 1200 is a representation of the malware detection system 200, as described in FIG. 2A. The computer system 1200 includes at least one central processing unit (CPU) 1218 that communicates with a number of peripheral devices via bus subsystem 1216. These peripheral devices can include a storage subsystem 1202 including, for example, memory devices and a file storage subsystem 1210, user interface input devices 1212, user interface output devices 1222, and a network interface subsystem 1220. The input and output devices allow user interaction with computer system 1200. Network interface subsystem 1220 provides an interface to outside networks, including an interface to corresponding interface devices in other computer systems.

In one implementation, a neural network 1212 is communicably linked to the storage subsystem 1202 and the user interface input devices 1214.

User interface input devices 1214 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1200.

User interface output devices 1222 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1200 to the user or to another machine or computer system.

Storage subsystem 1202 stores programming and data constructs that provide the functionality of some or all of the modules and methods described herein. These software modules are generally executed by deep learning processors 1224.

Deep learning processors 1224 can be graphics processing units (GPUs), field-programmable gate arrays (FPGAs), application-specific integrated circuits (ASICs), and/or coarse-grained reconfigurable architectures (CGRAs). Processors 1224 can be hosted by a deep learning cloud platform such as Google Cloud Platform™, Xilinx™, and Cirrascale™. Examples of processors 1224 include Google's Tensor Processing Unit (TPU)™, rackmount solutions like GX4 Rackmount Series™, GX6 Rackmount Series™, NVIDIA DGX-1™, Microsoft's Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 1204 used in the storage subsystem 1202 can include a number of memories including a main random-access memory (RAM) 1206 for storage of instructions and data during program execution and a read only memory (ROM) 1208 in which fixed instructions are stored. A file storage subsystem 1210 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1210 in the storage subsystem 1202, or in other machines accessible by the processor.

Bus subsystem 1216 provides a mechanism for letting the various components and subsystems of computer system 1200 communicate with each other as intended. Although bus subsystem 1216 is shown schematically as a single bus, alternative implementations of the bus subsystem can use multiple buses.

Computer system 1200 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 1200 depicted in FIG. 12 is intended only as a specific example for the purpose of illustrating the preferred implementations of the present technology disclosed. Many other configurations of computer system 1200 are possible having more or fewer components than the computer system depicted in FIG. 12.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for automated generation of training data in a malware detection system, the method comprising:
acquiring metadata from one or more data sources for a plurality of malware samples,
applying a coarse filtering function to the metadata for generating a first subset of malware samples,
performing a granular selection for the first subset, comprising:
extracting one or more features from each of the plurality of malware samples in the first subset, and
grouping malware samples based on similarities among the extracted features to form at least one cluster;
generating a second subset of malware samples from the at least one cluster representing diversity across a plurality of malware families and threat categories; and
comparing the second subset with a predefined threshold, indicating at least one of a minimum number of new malware samples or a target distribution of threat categories, for determining if the second subset satisfies the predefined threshold;
wherein a machine learning model is trained for malware detection using the second subset upon determining that the second subset satisfies the predefined threshold.

2. The method of claim 1, further comprising storing the acquired metadata in a data repository configured to facilitate querying based on metadata attributes, wherein the metadata includes at least a file identifier and at least one behavioural or static file attribute.

3. The method of claim 1, wherein the coarse filtering function applies one or more broad criteria including at least a threat severity level or submission date.

4. The method of claim 1, further comprising modifying the predefined threshold based on historical model performance metrics that include at least one of accuracy, precision, recall, or false-positive rate.

5. The method of claim 1, wherein the data repository is partitioned according to submission dates, threat categories, or file attributes to enable faster retrieval of metadata.

6. The method of claim 1, wherein the step of granular selection further comprises applying a dimensionality reduction process prior to grouping the malware samples into clusters.

7. The method of claim 1, further comprising monitoring the second subset for redundancy by comparing newly selected malware samples to previously used training data, and excluding duplicates before initiating a training process.

8. The method of claim 1, wherein the coarse filtering function excludes malware samples below a specified threat severity level to reduce the data volume processed in the granular selection operation.

9. The method of claim 1, wherein the second subset is updated to increase diversity if the number of samples associated with an underrepresented malware family is below a defined threshold.

10. The method of claim 1, further comprising logging at least one performance metric from the initiated training process, and adjusting one or more filtering parameters of the coarse filtering process in response to suboptimal performance.

11. The method of claim 1, further comprising applying a scheduling mechanism to automatically repeat the steps of acquiring metadata, applying the coarse filtering function, performing the granular selection, generating a second subset, and comparing at predetermined intervals or upon detecting at least one trigger event that indicates a change in threat landscape or model performance.

12. A non-transitory computer-readable medium storing instructions that, when executed by one or more processors, cause a computing system to perform operations comprising:
acquiring metadata from one or more data sources for a plurality of malware samples,
applying a coarse filtering function to the metadata for generating a first subset of malware samples,
performing a granular selection for the first subset, comprising:
extracting one or more features from each of the plurality of malware samples in the first subset, and
grouping malware samples based on similarities among the extracted features to form at least one cluster;
generating a second subset of malware samples from the at least one cluster representing diversity across a plurality of malware families and threat categories; and
comparing the second subset with a predefined threshold, indicating at least one of a minimum number of new malware samples or a target distribution of threat categories, for determining if the second subset satisfies the predefined threshold;
wherein a machine learning model is trained for malware detection using the second subset upon determining that the second subset satisfies the predefined threshold.

13. The non-transitory computer-readable medium of claim 12, wherein the instructions further cause the computing system to adjust the predefined criteria for coarse filtering in real time based on detection gaps identified in current model performance.

14. The non-transitory computer-readable medium of claim 12, wherein the instructions further cause the computing system to apply at least one dimensionality reduction technique to the extracted features to facilitate the grouping operation.

15. The non-transitory computer-readable medium of claim 12, wherein the instructions further cause the computing system to log metadata describing the second subset and to provide a record of each sample selected for the automated model training routine.

16. The non-transitory computer-readable medium of claim 12, wherein the instructions further cause the computing system to revise the second subset by adding or removing malware samples if the diversity level of the second subset is below a specified threshold.

17. A malware detection system for automated generation of training data in a malware detection environment, the system comprising:
a data repository configured to store metadata corresponding to a plurality of malware samples, wherein the data repository is partitioned based on at least one attribute selected from the group consisting of submission date, threat classification, or file type;
one or more processors coupled to the data repository and configured to execute machine-readable instructions that:
acquire metadata from one or more data sources for a plurality of malware samples, apply a coarse filtering function to the metadata for generating a first subset of malware samples,
perform a granular selection for the first subset by:
extracting one or more features from each of the plurality of malware samples in the first subset, and
grouping malware samples based on similarities among the extracted features to form at least one cluster;
generate a second subset of malware samples from the at least one cluster representing diversity across a plurality of malware families and threat categories; and
compare the second subset with a predefined threshold, indicating at least one of a minimum number of new malware samples or a target distribution of threat categories, for determining if the second subset satisfies the predefined threshold;
wherein a machine learning model is trained for malware detection using the second subset upon determining that the second subset satisfies the predefined threshold.

18. The system of claim 17, further comprising a user interface configured to display at least one visualization of the clustering results and to provide an option for manual override of the second subset selection.

19. The system of claim 17, wherein the one or more processors are further configured to maintain a version history of each retraining iteration, the version history including details of the selected malware samples and resulting model performance.

20. The system of claim 17, further comprises a monitoring module configured to track performance metrics of the retrained machine learning model and to adjust at least one parameter of the coarse filtering operation based on the tracked performance metrics, wherein the monitoring module is further configured to send notifications to an administrative dashboard upon completion of each retraining process, the notifications indicating at least the volume of samples added and the model's updated detection metrics.
